(19) United States
(12) Patent Application Publication
(10) Pub. No.: US 2010/0139137 A1
(43) Pub. Date: Jun. 10, 2010

(54) HAND HELD SIGN

(76) Inventor: Raymond Coutu, Gatineau (CA)

Correspondence Address: Harding, Early, Follmer & Frailey, 1288 Valley Forge Road, P.O. Box 750, Valley Forge, PA, 19482-0750, US

(21) Appl. No.: 12/449,011

(22) PCT Filed: Jan. 25, 2008
(86) PCT No.: PCT/CA2008/000158

§ 371 Date: Jan. 11, 2010

(30) Foreign Application Priority Data
Feb. 13, 2007 (CA) 2578452

(51) Int. Cl. G09F 21/02

(52) U.S. Cl. 40/586

(57) ABSTRACT

A hand held sign comprising, a support medium adapted to display a message, text, image or other indicia and having two holes in spaced relationship to one another therein and a handle to support the support medium wherein the handle is formed by that support medium material that remains between the two holes.

### FIELD OF THE INVENTION

The present invention relates to hand held signs and particularly relates to hand held signs for use at rallies, sporting events and other gatherings.

### BACKGROUND OF THE INVENTION

In sporting events, public demonstrations and during political conventions and other like events, signs are held up by participants advertising the product they promote, the team they are cheering for, the position taken on policy or the name of the political candidate or party they favour. These signs have traditionally been made out of a support medium made of rigid material such as corrugated plastic, plastic or cardboard printed with a message on one or both sides, the support medium being attached (for example, nailed, stapled, or otherwise) to a wooden (or for example, metal or plastic) stick or dowel by which the participant holds and manipulates the sign. However, security concerns have arisen that the sticks or dowels could be used as weapons during the event and for this reason, the event holders and public security forces are reluctant to allow these “traditional” signs at these events.

Accordingly there is a need for a sign which does not present, or which reduces the security concern that the sticks or dowels of the traditional signs could be used as weapons during events, which sign is also attractive and useful in displaying the desired information or message. Additionally it is desirable to have a sign that is easy to manufacture, and which can be readily transported in “ready to use” format without requiring further assembly by the user. It is also desirable to provide a sign that has an handle which is ergonomic and comfortable for the user, and which permits the user to readily hold and manipulate the sign.

### SUMMARY OF THE INVENTION

It is an object of the present invention to provide a sign which does not utilize a stick or dowel for the support thereof and which does not present, or which reduces the security concern that a sticks or dowels could be used as weapons during events.

It is a further object of the present invention to provide a sign which is attractive and useful in displaying the desired information or message and which is easy to manufacture, and which can be readily transported in “ready to use” format without requiring further assembly by the user, and which sign handle which is ergonomic and comfortable for the user, and which permits the user to readily hold and manipulate the sign.

According to one aspect of the present invention, there is provided a hand held sign comprising a support medium adapted to display a message, text, image or other indicia and having two holes in spaced relationship to one another therein, and a handle to support the support medium, wherein the handle is formed by that support medium material that remains between the two holes.

Advantageously, the present invention provides a sign which is attractive and useful in displaying the desired information or message and which is easy to manufacture and which sign does not utilize a stick or dowel for the support thereof, thereby eliminating or reducing security concerns associated with sticks or dowels being used as weapons. Furthermore, the present invention advantageously provides a sign which can be readily transported in “ready to use” format without requiring further assembly by the user, and which sign handle which is ergonomic and comfortable for the user, and which permits the user to readily hold and manipulate the sign.

### BRIEF DESCRIPTION OF THE DRAWINGS

A preferred embodiment of the present invention is described below with reference to the accompanying drawings, in which:

FIG. 1 is a front elevation view of the sign of one embodiment of the present invention;

FIG. 2 is a side elevation view of the sign of one embodiment of the present invention;

FIG. 3 is a back elevation view of the sign of one embodiment of the present invention.

### DETAILED DESCRIPTION OF THE PREFERRED EMBODIMENT

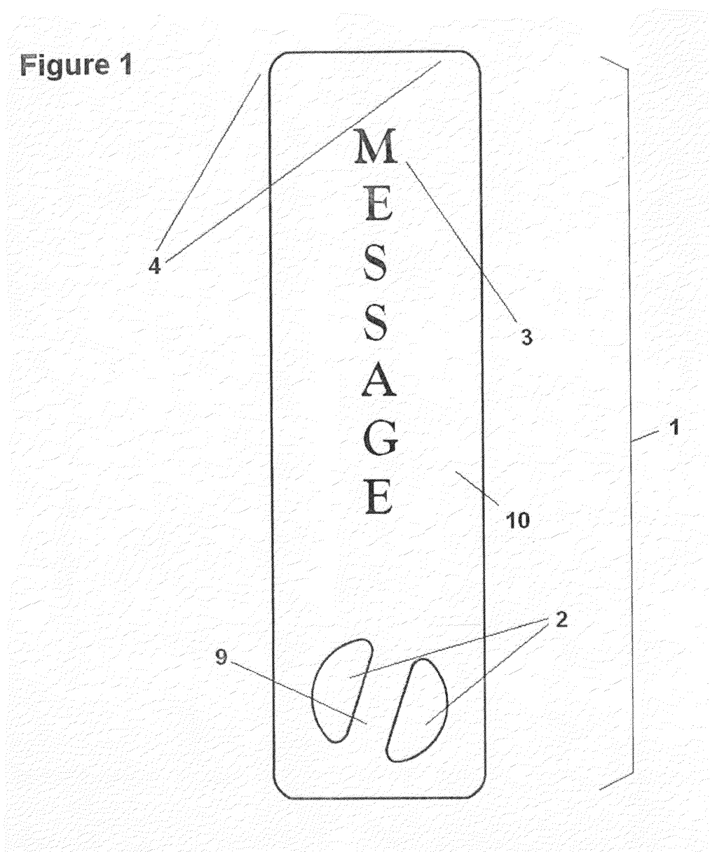

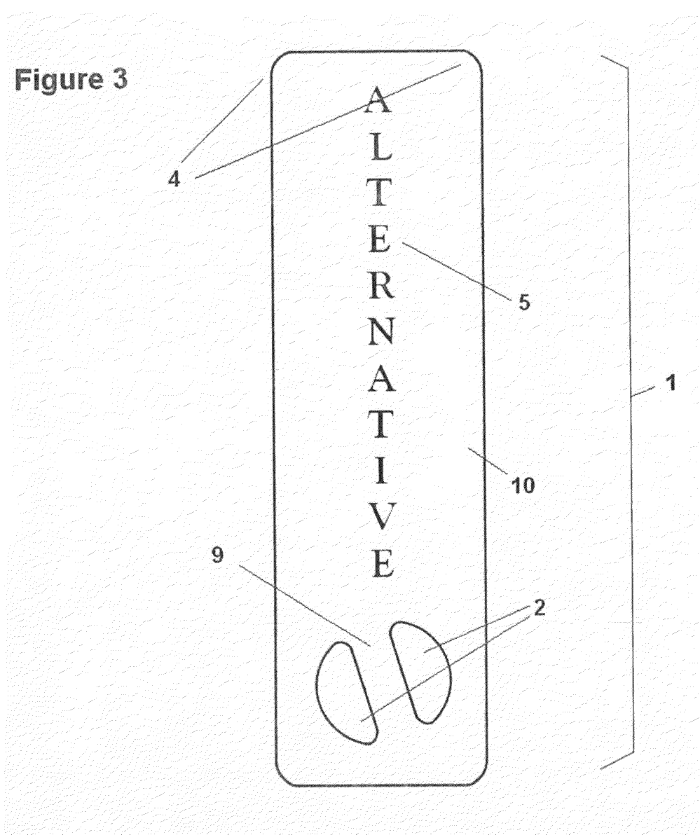

With reference to FIGS. 1 and 3, a sign generally identified by reference numeral 1 is provided. In a preferred embodiment, a support medium 10 of size, shape and orientation suited to the event and message to be displayed is provided (it being understood that a wide variety of shapes, sizes and orientations may be the subject matter of the present invention, including, for example squares, rectangles, circles, ovals and other fanciful shapes, and vertical, horizontal or diagonal orientations as would be understood by a person skilled in the art).

In the embodiment illustrated in FIGS. 1 and 3 a generally rounded rectangular design is provided, the rounded corners 4 of the design of this embodiment providing additional safety characteristics for the sign, eliminating sharp corners associated with the 90 degree angles on the corners of a rectangle.

In the preferred embodiment, the support medium 10 is made of a thin sheet of corrugated cardboard, it being understood that a wide variety of different materials may alternatively be utilized, including, for example thick paper, non-corrugated cardboard, plastic sheeting or corrugated plastic, and other materials known to a person skilled in the art. The front surface of the support medium may be used to display a message 3 or other text, image or indicia, generally shown as the word MESSAGE 3. Similarly, as illustrated in FIG. 3, the rear surface of the support media may be used to display the same, or an alternative message or other text, image or indicia, generally shown as the word ALTERNATIVE 5 in FIG. 3. The message text, image or other indicia may be printed, affixed or otherwise displayed on the surfaces of the support media in a manner known to a person skilled in the art. In an alternative embodiment, thick card stock paper (or any other printing substrate as would be known to a person skilled in the art) may utilized in the context of the present invention, the text, image or indicia being printed on the card stock or other substrate and thereafter applied to the support medium by gluing, lamination or such other manner as would be known to a person skilled in the art. This embodiment also provides an additional functional characteristic as it provides additional stiffness and strength.

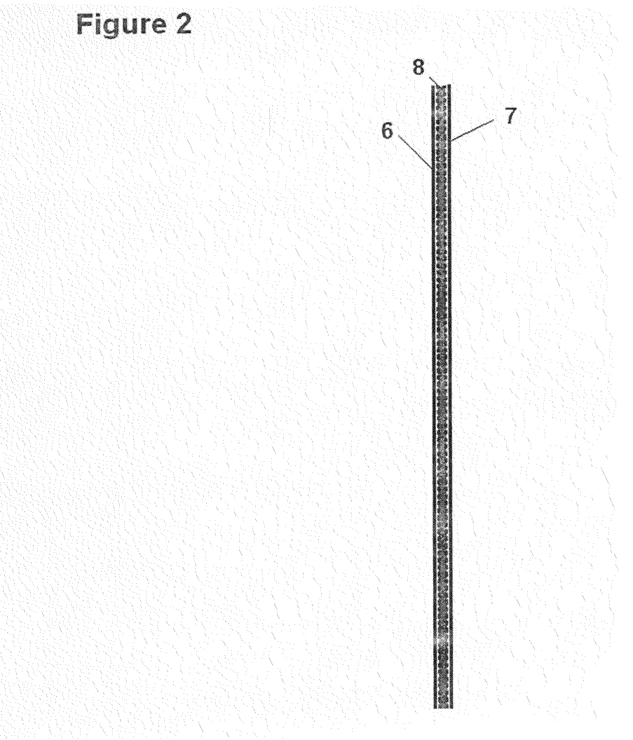

As illustrated in the cross-sectional view of FIG. 2, in the preferred embodiment of the present invention, the support media may be corrugated cardboard, having a forward facing surface 6 and rearward facing surface 7, and sandwiched there-between a thin layer of corrugating cardboard material 8 which has been glued or otherwise securely attached to both the forward facing surface 6 and rear ward facing surface 7 to provide a rigid or semi-rigid support medium in a manner known to person skilled in the art. In alternative embodiments of the present invention, alternative structures may be used in respect of the support medium as would be understood by a person skilled in the art.

In the preferred embodiment of the present invention, as illustrated in FIGS. 1 and 3, there is provided, as an integral part of the support medium, a handle 9 formed by two generally half-moon shaped 2 holes provided in the support medium, the handle 9 in the preferred embodiment being positioned and angled from the vertical so as to provide an ergonomically suitable grip and angle from the vertical to allow for a comfortable, yet solid grip. In the preferred embodiment, the half-moon shaped 2 holes are slightly larger than the size required to permit a gloved human hand to pass easily therethrough it being understood that the size of these holes may vary and be adapted for the use of the users as would be understood by a person skilled in the art. In the preferred embodiment, the handle is angled at between 10 and 20 degrees from the vertical, and preferably at approximately 17 degrees from the vertical, it being understood that a wide range of angles may alternatively be selected to suit the preferences of the users of the signs. As the sign's messages or images may be printed or otherwise affixed to either side of the sign, the sign may readily be reversed, thereby reversing the orientation of the handle relative to the displayed message, to permit the sign to be readily used by left handed and right handed users. It is also understood that in alternative embodiments of the present invention, the holes 2 may be square, rectangular or such other shape as would be understood by a person skilled in the art. In the preferred embodiment, the handle 9 is positioned in the lower part of the support medium, it being understood that in alternative embodiments, the handle 9 may be positioned elsewhere on the support medium, such as, for example, in the middle or upper parts of the support medium.

To use the sign of the present invention, one or more messages, images or other indicia is printed, affixed or otherwise displayed one or both surfaces of the support media in a manner known to a person skilled in the art, and at the event for which the sign is being utilized, the user, in the case of the preferred embodiment, inserts the fingers of one hand into one of the holes 2 and inserts the thumb in the other, thereby positioning the handle 9 of the sign in the palm of the user's hand where it can be readily and securely grasped and manipulated by the user.

The present invention has been described herein with regard to preferred embodiments. However, it will be obvious to persons skilled in the art that a number of variations and modifications can be made without departing from the scope of the invention as described herein.

1. A hand held sign comprising:
a. a support medium adapted to display a message, text, image or other indicia and having two holes in spaced relationship to one another therein; and
b. a handle to support the support medium wherein the handle is formed by that support medium material that remains between the two holes.

2. A hand held sign according to claim 1 wherein the handle has an angle of between 10 and 20 degrees to the vertical.

3. A hand held sign according to claim 1 wherein the support medium is corrugated cardboard.

4. A hand held sign according to claim 1 wherein the message, text, image or other indicia is printed or affixed to thick card stock paper or other printing substrate and thereafter securely attached to the support medium.

5. A hand held sign according to claim 2 wherein the support medium is corrugated cardboard.

6. A hand held sign according to claim 2 wherein the message, text, image or other indicia is printed or affixed to thick card stock paper or other printing substrate and thereafter securely attached to the support medium.

7. A hand held sign according to claim 3 wherein the message, text, image or other indicia is printed or affixed to thick card stock paper or other printing substrate and thereafter securely attached to the support medium.

8. A hand held sign according to claim 5 wherein the message, text, image or other indicia is printed or affixed to thick card stock paper or other printing substrate and thereafter securely attached to the support medium.
